(19) United States
(12) Patent Application Publication
(10) Pub. No.: US 2015/0271291 A1
(43) Pub. Date: Sep. 24, 2015

(54) METHOD AND SYSTEM FOR PROVIDING ADDITIONAL CONTENT TO THE USER OF THE INTERNET NETWORK

(71) Applicant: NEW MEDIA TUBE SP. ZO.O., Warszawa (PL)

(72) Inventors: Tomasz Wlaszczuk, Warszawa (PL); Jacek Trzcinski, Warszawa (PL); Dariusz Tyc, Plonsk (PL); Stefan Garus, Warszawa (PL)

(21) Appl. No.: 14/431,952

(22) PCT Filed: Sep. 27, 2013
(86) PCT No.: PCT/PL2013/000125

§ 371 Date: Mar. 27, 2015

(30) Foreign Application Priority Data
Sep. 28, 2012 (PL) P.400 980

(51) Int. Cl. H04L 29/08; G06F 17/30; H04L 12/721

(52) U.S. Cl. CPC H04L 67/32; H04L 45/14; G06F 17/3089

(57) ABSTRACT

A system comprises a routing module (2) connected to the Internet (1), to an ad server (4), to a web server (5) and to a management module (6), the routing module being situated between the user device (3) which accesses the Internet (1) via an Internet provider. By means of a routing system, including the routing module and the management module, http traffic of the user device is analyzed and upon detecting a request for a new web site, at least one additional web site is inserted into the stream of data and additional content is provided.

### CROSS REFERENCE TO RELATED APPLICATION

This application claims benefit pursuant to 35 U.S.C. §365 of PCT Patent Application No. PCT/PL2013/000125 filed 27 Sep. 2013 which claims priority of Polish Patent Application P.400980 filed 28 Sep. 2012, the disclosure of each of which is incorporated herein by reference in its entirety.

### TECHNICAL FIELD

Example embodiments relate to methods and systems for providing additional content, especially providing advertisements, to users of the Internet network or other networks.

### BACKGROUND

Nowadays, the Internet is an omnipresent medium which can be accessed not only at home, in Internet cafes, in libraries, but also in cafes, in waiting rooms, at railway stations, in bookstores, and in different points in the city. In addition, the mobile Internet service is available from each mobile network operator and allows access to the Internet network from virtually anywhere. As a result, the Internet has become an ideal carrier of information for things such as different types of news, such as economic or political, a place for virtual meeting at online forums or portals, a global multimedia library, and enables users to book and to buy tickets, to check on the weather or sports scores, all using computer based user devices.

More and more people have easier access to the Internet, it is now used in virtually every area of life and is an important medium for information, in particular for advertising. It is difficult to find on the Internet, a web site without any advertisements. These may include advertisements, for example, in the form of web sites, banner advertisements, calling cards, top-layer, pop-up and pop-under advertisements, (interstitial) Internet spots, sponsorship campaigns, boxes or search engine advertisements.

It is known to provide information to the user in the form of advertisements or in other forms based on the history of the user behavior on the network. Methods for providing particular content to the user based on his behavior are described, among others, in U.S. patent applications US 20090204706 A1, US 20060212353 A1, US 20080222283 A1 and US 20100023581 A1, the disclosures of each of which are incorporated herein by reference in their entirety.

From U.S. patent application 20080222283 A1, there is known a method for providing targeted (personalized) content to the client, comprising: obtaining information about the client behavior (“behavioral information”) from the client's devices or from the users of the client's devices in the network environment, and selecting and providing content (for example an advertisement) to the client's device based on the client behavior. The solution is based on a proxy device on which traffic is observed and, on this basis, selection of an advertisement to be sent to the browser along with the existing site is made. This solution, however, does not include any information about an additional new web site.

Moreover, from U.S. patent application 20060212353 A1, there is known a system including a targeted (personalized) advertising server which provides advertising material to the browser which is operatively connected to the Internet network by the information service provider (ISP). The system comprises a database containing a lot of advertisements and a matching mechanism, operatively connected to the database. The matching mechanism comprises instructions adapted to the received browsed information, readable by the computer with the information being transmitted to the system including the targeted advertising server by the ISP system. In the ISP system, the browsed information refers to one or many web sites requested by the browser and is received by a content reader used in the ISP system to work on the requested web sites. In other words, the solution relates to an ad server system which receives advertisements based on additional data obtained from the ISP (based on cookies).

Advertising content is “added” to the already existing site; that is, generation of a new web site does not occur.

In U.S. patent application 20120131609 A1, the disclosure of which is incorporated herein by reference in its entirety, a method for selecting targeted advertising content is disclosed. According to one embodiment, the method comprises receiving, based on a social network site, from a computing device of the user of the social network site, the data identifying the user and, in addition, transmitting the data related to the transmitted content reproduced on the computing device. In addition to the access to the user information of the social network site, the social network site, through the transmitted data and the user information, selects content of the targeted advertisements to improve transmission of the content of the targeted advertisements to the computing device, where they are to be reproduced in combination with the transmitted content. In this solution, generation of an additional web site does not occur, and selection of advertising content is made based on the social network site with which the content is transmitted to the user.

From another U.S. patent application 2012204109 A1, the disclosure of which is incorporated herein by reference in its entirety, a system and a method for addressing the content to the user of a device or a network of devices are known. In an embodiment, profile information is determined based on the activity and/or behavior of the user on the network. One or more input signals are received from an external source for determining the type of content to be addressed to the user. One or more content items are chosen for addressing to the user based on profile information and on one or more input signals. Selection of the content items is performed without communication of profile information from outside the user's device or network.

From U.S. patent application 20110066608 A1, the disclosure of which is incorporated herein by reference in its entirety, a method and a system for providing specific content to the user are known. This method is implemented by the computer and comprises receiving the user request to access a web site, receiving the user data from the user request, the user data selected from a group consisting of revocation data, session data and a combination thereof, providing a rule for user data, related to the user request, in the program block of the user, providing memory in real time for identification of the content responsive to the user request based on the assigned program block of the user, generating a response to the user request using identical content, and sending the generated response to the user. The generated response may contain many different types of content identified based on the assigned program block of the user. The type of content used to generate the response may be determined based on the assigned program block of the user. Generating the response to the user request based on the assigned program block of the user may comprise determining the advertisement which is to be provided to the user.

Such prior methods and systems may benefit from improvements.

### SUMMARY

Example embodiments include a system and method for providing specific content to the network user. The system includes, among other features, at least one computer memory with which at least one processor is connected. The system includes a web server configured to receive a user site request, and to provide the site in response to the request. The example system further includes proxy rules in communication with a real time session server and with the web server. The proxy rules are configured for an appropriate user, or for a segment of a user group, based on the site request.

The example solution is therefore based on the proxy rules which receive the user request to access a web site from a web server, intercept the user data from the user request, use a rule for the user data to assign the user to a program block, generate the web site with contents using the used program block, and provide the personalized, generated web site to the user. The proxy rules on which the example solution is based, analyzes the user's request and using cache memory, sends the advertisement to the user.

An example arrangement is operated to insert additional web sites into a stream of sites browsed by the user in the browser of his device. The user receives attractive, full-screen advertisements, for example, related to the browsed content and/or the advertisements being placed on the additional, inserted web sites.

The method according to an example arrangement operates by performing an http traffic analysis detecting a user request for a new site. The arrangement then operates a routing system, to insert at least one additional web site into the stream of data, such that additional content is provided to the user.

In an example arrangement, upon detection of the request for a new site, it is checked whether this request relates to an html resource. When the condition that the request relates to an html resource is met, at least one additional web site is inserted into the stream of data and generally simultaneously the http traffic analysis is temporarily suspended.

In the example arrangement during the insertion of the at least one additional web site, the requested site is replaced with at least two web sites. The first of such web sites is the requested web site and the browser operates to record in the browser history the address of the requested web site. Subsequently the browser is redirected to another web site with additional content, with the passage to the requested site being achieved by referring to the browser history.

In exemplary arrangements, a processor implemented function is provided which achieves the passage to the requested site, by the function referring to the browser history. Further in exemplary arrangements during the insertion, the requested site is replaced with at least one web site, and the passage to the requested site is achieved by referring to the address of the requested web site. Further in exemplary arrangements during the insertion, the requested site is replaced with at least one web site including a last site, the last site allowing return to the requested site. Further in exemplary arrangements, during the insertion, the requested site is replaced with at least one web site including a last site, the last site allowing the user to return to the requested site by referring to a module of the requested site.

In the example arrangements, a useful aspect is that between the user of the Internet and the Internet provider, a routing module in communication with the Internet, with an ad server, with a web server and with a management module is provided.

In exemplary arrangements, the routing module and the management module are included in a routing system.

Exemplary arrangements are implemented in network structures such as an intelligent network router (INR) through which the transmission of user data passes. The exemplary method and the system presented may be used at existing access point names (APN) in GSM networks and at existing access points (AP) in wireless computer networks (WiFi).

### BRIEF DESCRIPTION OF DRAWING

FIG. 1 is a block diagram of an example system for providing additional content to the user.

### DETAILED DESCRIPTION

An exemplary system and method for providing additional content to the user comprises performing an analysis of Internet transmissions through operation of a specialized routing system. During the http traffic analysis, when a request for a new site sent by a user device is detected, it is checked to determine whether the request relates to an html resource. If this condition is met, the routing system operates to insert into the stream of data an additional web site, between the sites provided to the web browser, with the advertising content placed therein, and provides such additional web site to the user device while temporarily suspending the http analysis. During the exemplary insertion, the user requested site is replaced with two web sites, the first recording the address of the requested web site in the browser history, and the other containing the advertisement. The passage to the web site initially requested by the user is then achieved by referring to the browser history.

In another example arrangement, the passage to the requested site is achieved by means of a button selection, that is, by an appropriate function.

In yet another example arrangement, two web sites with advertisements are inserted, the last site allowing or with instructions for causing a browser of the user device to enter the web site requested by the user.

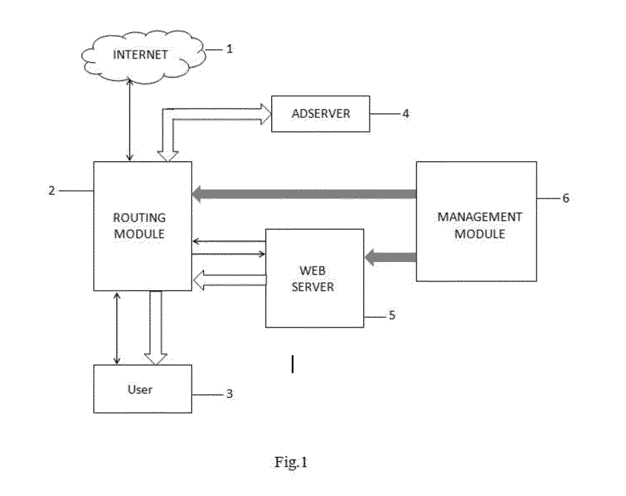

As represented in FIG. 1, an example system for providing additional content to the user comprises a routing module 2 connected to an Internet 1 provider, to the user device 3, to an ad server 3 and to a web server 5. Further, the routing module 2 operatively connects to a management module 6, thereby forming a routing system. The management module 6 supervises operation of the routing module 2, sets interval parameters between the inserted advertisements, selects an appropriate ad server 4 and a method of redirecting. By connecting to the web server 5, the management module 6 sends back the packets containing redirection instructions, data and/or content. One or more computers including processors and data storage media bearing computer executable instructions may include such modules and servers.

Of course it should be understood that the described elements are merely representative of functions carried out through exemplary systems of the types that have been described herein. Numerous different variations of such elements, devices, processes and steps may be implemented in accordance with approaches that have been described. Further such elements may be implemented in various arrangements of computer devices and software programs including devices operative to hold non-transitory computer executable instructions.

Thus the exemplary systems and methods that have been described herein achieve desirable capabilities, eliminate difficulties encountered in the use of prior devices and systems and attain the useful results described herein.

In the foregoing description, certain terms have been used in connection with describing exemplary embodiments for purposes of brevity, clarity and understanding. However, no unnecessary limitations are to be implied therefrom because such terms are used for descriptive purposes and are intended to be broadly construed. Moreover the descriptions and illustrations herein are by way of examples and the inventions are not limited to the particular features shown and described.

Further it should be understood that elements, features, relationships, devices and other aspects described in connection with one exemplary embodiment may be utilized in connection with other exemplary embodiments such that numerous different arrangements, functions and capabilities may be carried out. Numerous different aspects of described embodiments may be used together or in different combinations to achieve useful results.

Having described the features, discoveries and principles of the exemplary embodiments, the manner in which they are constructed and operated, and the advantages and useful results attained, the new and useful structures, devices, elements, arrangements, parts, combinations, systems, equipment, operations, methods, processes and relationships are set forth in the appended claims.

We claim:

1. A method for providing additional content to a user of an Internet network, comprising:
(a) operating a routing system to analyze individual transmission packets communicated by a user device and detect a probable request for http protocol concerning a new web site call,
(b) operating the routing system responsive at least in part to the detection, to insert at least one additional web site into the stream of data, whereby additional content is provided to the device.

2. The method according to claim 1, wherein in (a) the packets in layer 3 are analyzed.

3. The method according to claim 1,
wherein (a) further includes operating the routing system to cause to be determined whether the request relates to an html resource,
and wherein in (b) the insertion of at least one additional web site into the stream of data is carried out responsive at least in part to the determination,
responsive at least in part to the determination and generally simultaneously with such determination, operating the routing system to temporarily suspend analysis of transmission packets and insertion of the additional web sites for the user device.

4. The method according to claim 3, wherein in (b) the insertion includes replacing the requested site with at least two web sites, at least one of such web sites being operative to cause at least in part by means of a browser, at least one of,
(i) recording in a browser history, an address of the requested web site,
(ii) the browser being redirected to another web site with additional content,
(iii) passage from the web site with the additional content to the requested web site by referring to the browser history.

5. The method according to claim 4,
wherein in (b) the passage from the web site with the additional content to the requested site is caused responsive at least in part by operation of a function referring to the browser history.

6. The method according to claim 4,
wherein in (b) the insertion includes replacing the requested site with at least one different web site, and wherein the passage to the requested site is caused responsive at least in part by referring to the address of the requested web site.

7. The method according to claim 3,
wherein in (b) the insertion includes replacing the requested site with at least one different web site, including a last site, and the last site allowing return to the requested site.

8. The method according to claim 7,
wherein in (b) the insertion includes replacing the requested site with at least one different web site, including the last site, the last site allowing return to the requested site by referring to a module indicating the requested site.

9. The method according to claim 6
prior to (a), receiving with the routing system from the user device, the transmission packets.

10. The method according to claim 9
wherein (b) includes operating the routing system to cause the requested web site to be provided to the browser.

11. The method according to claim 10 wherein in (b) the requested web site is provided from the Internet.

12. The method according to claim 10, wherein in (b) the at least one different web site is received responsive to operation of an ad server.

13. The method according to claim 12
wherein in (b) the operation of the routing system includes selection of the ad server.

14. The method according to claim 13, wherein the routing system includes a routing module and a management module, wherein in (b) the management module controls operation of the routing module to cause replacement of the requested web site with the at least one different web site.

15. The method according to claim 14
wherein in (b) the management module is operative to cause operation of a web server, wherein the web server operates to cause redirection data to be sent to the routing module, wherein the redirection data corresponds with at least one different web site.

16. A system comprising:
at least one computer, including a routing module and a management module,
wherein the at least one computer is operatively positioned between a user device and the Internet,
wherein the at least one computer is operative responsive at least in part to operation of the routing module and the management module to cause
transmission packets communicated by the device to be analyzed to identify a probable http protocol corresponding to a new web site call corresponding to a requested web site,
responsive at least in part to the identification, causing the device to receive at least one different web site before receipt of the requested web site.

17. The system according to claim 16
wherein the at least one computer is operative to cause the device to receive data that causes the device to receive the requested web site after receipt of the at least one different web site.

18. The system according to claim 17
wherein the at least one computer is operative to cause data corresponding to the requested web site to be stored in a browser history,
wherein the requested web site is received by the device responsive at least in part to the browser history.

19. The system according to claim 18
wherein the at least one computer is operative to cause selection of an ad server, wherein the at least one different web site is received by the device responsive at least in part to operation of the selected ad server.

20. The system according to claim 19
wherein the system further includes a web server, wherein the web server is in operative connection with the routing module and the management module, wherein the web server is operative to cause redirection data to be provided to the routing module, wherein the at least one different web site corresponds at least in part with the redirection data.
